(19) United States
(12) Patent Application Publication
(10) Pub. No.: US 2013/0103838 A1
(43) Pub. Date: Apr. 25, 2013

(54) SYSTEM AND METHOD FOR TRANSFERRING GUEST OPERATING SYSTEM

(71) Applicants: Guang-Jian Wang, Shenzhen City (CN); Wen-Wu Wu, Shenzhen City (CN); Meng-Zhou Liu, Shenzhen City (CN); Xiao-Jun Fu, Shenzhen City (CN)

(72) Inventors: Guang-Jian Wang, Shenzhen City (CN); Wen-Wu Wu, Shenzhen City (CN); Meng-Zhou Liu, Shenzhen City (CN); Xiao-Jun Fu, Shenzhen City (CN)

(21) Appl. No.: 13/631,883

(22) Filed: Sep. 29, 2012

(30) Foreign Application Priority Data
Oct. 19, 2011 (CN) 201110320227.0

(51) Int. Cl. G06F 15/173

(52) U.S. Cl. 709/226

(57) ABSTRACT

A method for transferring one or more guest operating system (OS) using a remote server. The remote server periodically obtains a central processing unit (CPU) utilization ratio of each guest OS installed in each cloud server of the data center. The remote server counts the number of times of obtaining the CPU utilization ratio, and calculates a predicted average of the CPU utilization ratio for each cloud server if the counted number of the times is equal to a predetermined number. The remote server transfers one or more guest OS from the cloud server to other cloud servers before a predetermined time, in response to a determination that the predicted average of the CPU utilization ratio of the cloud server is greater than a predetermined average.

### BACKGROUND

1. Technical Field

Embodiments of the present disclosure relate to virtual machine technology, and particularly to a guest operating system (OS) transferring system and method.

2. Description of Related Art

A guest operating system (OS) runs in a virtualized environment. The virtualized environment virtualizes a personal computer or a server on an OS kernel layer. By using the virtualized environment, multiple guest OS can co-exist and run independently on the same computer. Each guest OS may use processing time of a CPU of a computer, which is measured by a CPU utilization ratio of the CPU (e.g., 60% capacity usage of a CPU). The computer may run too slow when the CPU utilization ratio used by all guest OS installed in the computer exceeds a threshold (e.g., 80% capacity usage of a CPU). In such a situation, a user may have to stop the application(s) hogging the CPU processing time and delete or transfer one or more of the guest OS to other computers. This is tedious and thus, there is room for improvement in the art.

### BRIEF DESCRIPTION OF THE DRAWINGS

FIG. 1 is a system view of one embodiment of a guest OS transferring system.

FIG. 2 is a block diagram of one embodiment of a remote server included in FIG. 1.

FIG. 3 is a flowchart of one embodiment of a guest OS transferring method.

### DETAILED DESCRIPTION

The disclosure, including the accompany drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

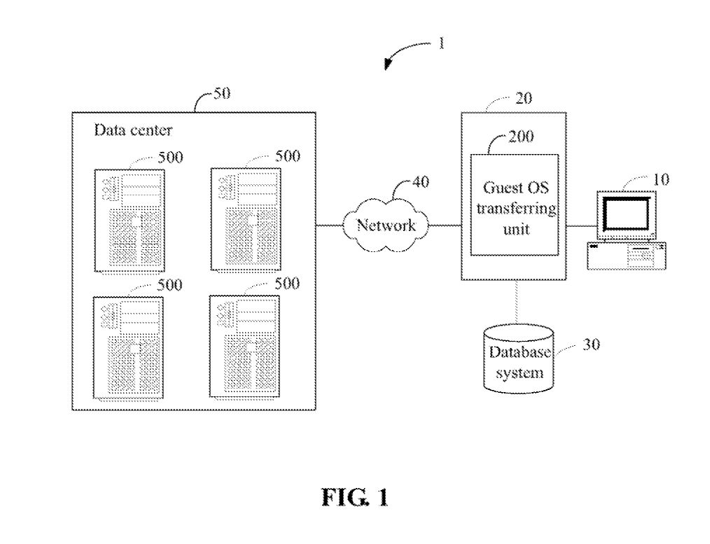

FIG. 1 is a system view of one embodiment of a guest operating system (OS) transferring system 1. In one embodiment, the guest OS transferring system 1 may include a remote server 20 and a data center 50. The data center 50 is designed for cloud computing capability and capacity including a plurality of cloud servers 500. The remote server 20 is connected to one or more client computers 10, and connected to the data center 50 via a network 40. The network 40 may be a wide area network (e.g., the Internet) or a local area network. The guest OS transferring system 1 may be used to monitor a CPU utilization ratio of each of the cloud servers 500. Using open database connectivity (ODBC) or java database connectivity (JDBC), for example, the remote server 20 is connected to a database system 30. The database system 30 may store the CPU utilization ratio, which is obtained by the remote server 20. Additionally, each of the one or more client computers 10 provides an operation interface for controlling one or more operations of the remote server 20.

The cloud servers 500 store the CPU utilization ratio. The CPU utilization ratio may show performance of the cloud servers 500 and be generated by the cloud servers 500 themselves when the cloud servers 500 run. Additionally, the cloud servers 500 may store a serial number of each cloud server 500, a voltage of each cloud server 500, a rotational speed of a fan of each cloud server 500, a temperature of each cloud server 500, a status of each cloud server 500 (e.g., power on/off), a memory utilization ratio of each cloud server 500, a disk utilization ratio of each cloud server 500, and network traffic of each cloud server 500.

Each cloud server 500 is installed with one or more guest operating systems (OS). In order to manage the one or more guest OS, each cloud server 500 is installed with a virtual machine management application (e.g., HYPERVISOR). The HYPERVISOR is used to manage and monitor execution of the one or more guest OS. The HYPERVISOR also obtains the CPU utilization ratio of each guest OS from each cloud server 500.

The remote server 20, in one example, can be also a dynamic host configuration protocol (DHCP) server, which provides a DHCP service. In one embodiment, the remote server 20 assigns Internet protocol (IP) addresses to the cloud servers 500 by the DHCP service. In one embodiment, the remote server 20 uses dynamic allocation to assign the IP addresses to the cloud servers 500. For example, when the remote server 20 receives a request from a cloud server 500 via the network 40, the remote server 20 dynamically assigns an IP address to the cloud server 500. In one embodiment, the remote server 20 may be a personal computer (PC), a network server, or any other data-processing equipment which can provide IP address allocation function.

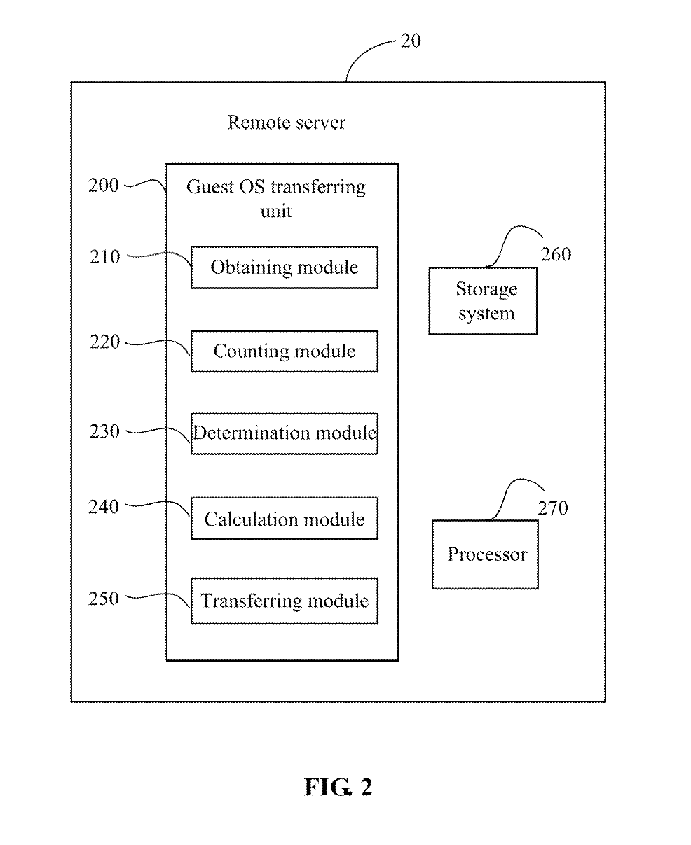

FIG. 2 is a block diagram of one embodiment of the remote server 20. The remote server 20 includes a guest OS transferring unit 200. The guest OS transferring unit 200 transfers the guest OS. The remote server 20 includes a storage system 260, and at least one processor 270. In one embodiment, the guest OS transferring unit 200 includes an obtaining module 210, a counting module 220, a determination module 230, a calculation module 240, and a transferring module 250. The modules 210-250 may include computerized code in the form of one or more programs that are stored in the storage system 260. The computerized code includes instructions that are executed by the at least one processor 270 to provide functions of the modules 210-250. The storage system 260 may be a memory device, such as an EPROM, HDD, or flash memory.

The obtaining module 210 periodically obtains a CPU utilization ratio of each guest OS installed in each cloud server 500 of the data center 50. The obtained CPU utilization ratio may be a percentage capacity usage of the CPU. In one embodiment, each guest OS includes a task manager, the task manager provides the CPU utilization ratio of the guest OS. The obtaining module 210 obtains the CPU utilization ratio from the task manager of the guest OS at a predetermined time (e.g., 1:00 AM per day). Regardless of the cloud sever 500 freezing up or not, the obtaining module 210 may still periodically obtain the CPU utilization ratio of each guest OS installed in the cloud server 500 many times (e.g., twenty four times). If the cloud server 500 freezes up, the CPU utilization ratio of each guest OS installed in the cloud server 500 is 100%. In addition, the obtaining module 210 further saves the obtained CPU utilization ratio into the database system 30 every time when the CPU utilization ratio is obtained from the task manager of the guest OS.

The counting module 220 counts the number of times of obtaining the CPU utilization ratio. In one embodiment, if the CPU utilization ratio is obtained twenty four times, the counting module 220 counts that the number of the times equals to twenty four times. In addition, the counting module 22 counts the number of times of obtaining the CPU utilization ratio until the number of times equal to a predetermined number.

The determination module 230 determines if the counted number of times is equal to the predetermined number. The predetermined number may be twenty four, for example.

The calculation module 240 calculates a predicted average of the CPU utilization ratio for each cloud server 500 if the counted number of the times is equal to the predetermined number. In one embodiment, the calculation module 240 calculates the average of the obtained CPU utilization ratio of each guest OS, then the calculation module 240 calculates the predicted average of the CPU utilization ratio of the cloud server 500 according to the average of the obtained CPU utilization ratio of each guest OS. The predicted average of the CPU utilization ratio of the cloud server 500 is equal to a summation of the average of the obtained CPU utilization ratio of each guest OS installed in the cloud server 500. The predicted average of the CPU utilization ratio of the cloud server 500 is regarded as the CPU utilization ratio of the cloud server 500 that would happen at the predetermined time.

The determination module 230 determines if the predicted average of the CPU utilization ratio of the cloud server 500 is greater than a predetermined average. The predetermined average may be set as 85%, for example.

The transferring module 250 transfers one or more guest OS from the cloud server 500 to other cloud servers 500 before the predetermined time, in response to a determination that the calculated average of the CPU utilization ratio of the cloud server 500 is greater than the predetermined average. The transferring module 250 transfers the one or more guest OS before the predetermined time, so as to avoid that the CPU utilization ratio of the cloud server 500 exceeds the predetermined time at the predetermined time in future. In one embodiment, the transferring module 250 invokes HYPERVISOR to transfer the one or more guest OS.

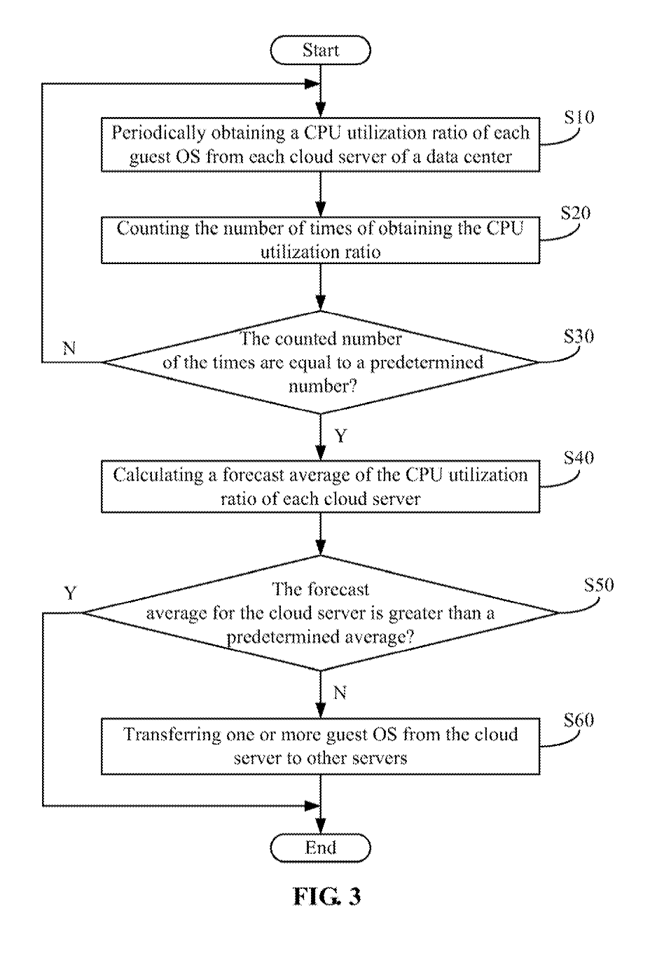

FIG. 3 is a flowchart of one embodiment of a guest OS transferring method. Depending on the embodiment, additional steps may be added, others deleted, and the ordering of the steps may be changed.

In step S10, the obtaining module 210 periodically obtains a CPU utilization ratio of each guest OS installed in each cloud server 500 of the data center 50. The obtaining module 210 obtains the CPU utilization ratio of the guest OS A and the CPU utilization ratio of the guest OS B at the predetermined time (e.g., at 1:00 AM per day.) In addition, the CPU utilization ratio of the guest OS A is saved into the database system 30, and the CPU utilization ratio of the guest OS B is saved into the database system 30.

In step S20, the counting module 220 counts the number of times of obtaining the CPU utilization ratio. In one embodiment, the counting module 240 may increase the number of times of obtaining the CPU utilization ratio by one after every time the CPU utilization ratio is obtained at 1:00 AM. For example, every time the CPU utilization ratio of the guest OS A is obtained at 1:00 AM, the counting module 240 increases the times of obtaining the CPU utilization ratio of the guest OS A by one.

In step S30, the determination module 230 determines if the counted number of the times is equal to a predetermined number. In one embodiment, assuming that the predetermined number is twenty four, if the counted number of the times is also equal to twenty four, the procedure goes to step S40. Otherwise, if the counted number of the times are less than twenty four, and the procedure returns to step S10.

In step S40, the calculation module 240 calculates a predicted average of the CPU utilization ratio for each cloud server 500 if the counted times are equal to a predetermined number. As mentioned above, the average of the CPU utilization ratio of the cloud server 500 is equal to a summation of the average of the obtained CPU utilization ratio of each guest OS installed in the cloud server 500. For example, if the cloud server 500 includes two guest OS A and B, the average of the obtained CPU utilization ratio of the guest OS A is calculated as 50%, the average of the obtained CPU utilization ratio of the guest OS B is calculated as 32%, then the predicted average of the CPU utilization ratio of the cloud server 500 is calculated as 82%. The predicted average of the CPU utilization ratio 82% is regard as the CPU utilization ratio of the cloud server 500 that would happen at 1:00 AM.

In step S50, the determination module 230 determines if the predicted average of the CPU utilization ratio of the cloud server 500 is greater than the predetermined average. In one embodiment, assuming that the predetermined average is 85%, if the predicted average of the CPU utilization ratio of the cloud server 500 is 88%, procedure goes to step S60. Otherwise, if the predicted average of the CPU utilization ratio of the cloud server 500 is 80%, and the procedure ends.

In step S60, the transferring module 250 transfers one or more guest OS from the cloud server 500 to other cloud servers 500 before the predetermined time. The transferring module 250 transfers the one or more guest OS before the predetermined time, so as to avoid that the CPU utilization ratio of the cloud server 500 exceeds the predetermined time at the predetermined time in future. In one embodiment, the transferring module 250 invokes HYPERVISOR to transfer the one or more guest OS. For example, assuming that the cloud server 500 includes two guest OS A and B, if the average of the CPU utilization ratio of the guest OS A is 60%, and the average of the CPU utilization ratio of the guest OS B is 22%, the transferring module 250 invokes HYPERVISOR to transfer the guest OS A to another cloud server 500 before 1:00 AM. Additionally, the transferring module 250 checks the average of the CPU utilization ratio of the another cloud server 500 to make sure that the another cloud server 500 is not overloading.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote server, the remote server in electronic communication with a plurality of cloud servers of a data center, the remote server comprising:
a storage system;
at least one processor; and
one or more programs stored in the storage system and being executable by the at least one processor, the one or more programs comprising:
an obtaining module periodically obtains a central processing unit (CPU) utilization ratio of each guest operating system (OS) installed in each cloud server of the data center;
a counting module counts the number of times of obtaining the CPU utilization ratio;
a calculation module calculates a predicted average of the CPU utilization ratio for each cloud server if the counted number of the times is equal to a predetermined number; and
a transferring module transfers one or more guest OS from the cloud server to other cloud servers before a predetermined time, in response to a determination that the predicted average of the CPU utilization ratio of the cloud server is greater than a predetermined average.

2. The remote server of claim 1, wherein the counting module increases the number of the times of obtaining the CPU utilization ratio by one after every time the CPU utilization ratio is obtained.

3. The remote server of claim 1, wherein the predicted average of the CPU utilization ratio of the cloud server is equal to a summation of the average of the obtained CPU utilization ratio of each guest OS installed in the cloud server.

4. The remote server of claim 1, wherein the obtaining module obtains the CPU utilization ratio of each guest OS installed in the cloud server from a virtual machine management application installed in the cloud server.

5. The remote server of claim 4, wherein the transferring module transfers the one or more guest OS using the virtual machine management application.

6. A computer-based guest OS transferring method being performed by execution of computer readable program code by a processor of a remote server, the remote server in electronic communication with a plurality of cloud servers of a data center, the method comprising:
obtaining periodically a central processing unit (CPU) utilization ratio of each guest OS installed in each cloud server of the data center;
counting the number of times of obtaining the CPU utilization ratio;
calculating a predicted average of the CPU utilization ratio for each cloud server if the counted number of the times is equal to a predetermined number; and
transferring one or more guest OS from the cloud server to other cloud servers before a predetermined time, in response to a determination that the predicted average of the CPU utilization ratio of the cloud server is greater than a predetermined average.

7. The method of claim 6, wherein the number of the times of obtaining the CPU utilization ratio increases by one after every time the CPU utilization ratio is obtained.

8. The method of claim 6, wherein the predicted average of the CPU utilization ratio of the cloud server is equal to a summation of the average of the obtained CPU utilization ratio of each guest OS installed in the cloud server.

9. The method of claim 6, wherein the CPU utilization ratio of each guest OS installed in the cloud server is obtained from a virtual machine management application installed in the cloud server.

10. The method of claim 9, wherein the one or more guest OS is transferred using the virtual machine management application.

11. A non-transitory computer-readable medium having stored thereon instructions that, when executed by a remote server, causing the remote server to perform a guest OS transferring method, the remote server in electronic communication with a plurality of cloud servers of a data center, the method comprising:
obtaining periodically a central processing unit (CPU) utilization ratio of each guest OS installed in each cloud server of the data center;
counting the number of times of obtaining the CPU utilization ratio;
calculating a predicted average of the CPU utilization ratio for each cloud server if the counted number of the times is equal to a predetermined number; and
transferring one or more guest OS from the cloud server to other cloud servers before a predetermined time, in response to a determination that the predicted average of the CPU utilization ratio of the cloud server is greater than a predetermined average.

12. The non-transitory medium of claim 11, wherein the number of the times of obtaining the CPU utilization ratio increases by one after every time the CPU utilization ratio is obtained.

13. The non-transitory medium of claim 11, wherein the predicted average of the CPU utilization ratio of the cloud server is equal to a summation of the average of the obtained CPU utilization ratio of each guest OS installed in the cloud server.

14. The non-transitory medium of claim 11, wherein the CPU utilization ratio of each guest OS installed in the cloud server is obtained from a virtual machine management application installed in the cloud server.

15. The non-transitory medium of claim 14, wherein the one or more guest OS is transferred using the virtual machine management application.
